(19) United States
(12) Patent Application Publication
(10) Pub. No.: US 2010/0241634 A1
(43) Pub. Date: Sep. 23, 2010

(54) METHOD AND SYSTEM OF RANKING TRANSACTION CHANNELS ASSOCIATED WITH REAL WORLD IDENTITIES, BASED ON THEIR ATTRIBUTES AND PREFERENCES

(76) Inventor: Ajay Madhok, Haryana (IN)

Correspondence Address: LESTER H. BIRNBAUM, 6 OAKMOUNT COURT, SIMPSONVILLE, SC, 29681, US

(21) Appl. No.: 12/734,178

(22) PCT Filed: Oct. 20, 2008
(86) PCT No.: PCT/IN2008/000691

§ 371 Date: Jun. 1, 2010

(30) Foreign Application Priority Data
Oct. 19, 2007 (IN) 2190/DEL/2007

(51) Int. Cl. G06F 17/30

(52) U.S. Cl. 707/748; 707/E17.044; 707/758

(57) ABSTRACT

A method and system for ranking transaction channels, for enabling transactions between two or more real world identities within one or more networks is provided. The real world identities have various transaction channels associated with them. Relationships between the real world identities and contexts are asserted by the identities, and also inferred by the system. Thereafter, a channel ranking score for each transaction channel is computed, based on the availability of the channel; and contexts and the relationships. The channels are ranked dynamically, and the most appropriate channel for transaction is selected based on the channel ranking scores.

### CROSS-REFERENCE TO RELATED APPLICATIONS

The present application claims a priority from a provisional patent application (PPA) filed in India, titled ‘Method and system of ranking transaction channels associated with real world identities, based on their attributes and preferences’. The priority application number for the PPA is 2190/DEL/2007, the priority date is 19 Oct. 2007 and the inventor is Ajay Madhok.

### FIELD OF THE INVENTION

The invention relates to systems and networks enabling any transaction in general. More specifically, the invention relates to a method and system for ranking transaction channels and enabling transactions.

### BACKGROUND OF THE INVENTION

In today's world, the Word Wide Web (Internet) has brought a revolution in the field of communication. The internet has played a vital role in bringing people close to fulfill various objectives. People share and access digital data, contact friends, send emails, shop, and pay their bills over the internet. In other words, people transact over internet in more than one ways. A transaction can be an agreement, communication, transfer or sharing carried out between two or more identities, involved in the exchange of information, goods, services and money.

In general, a transaction is defined as an exchange between end-points that may belong to same or different domains or networks. A transaction usually involves two identities (source and destination) but can extend to involve multiple identities to form an n-way exchange. Therefore, the need for a secure transaction is obvious. A transaction is not limited to two identities over a network, it is extendable to multi-identity and multi-network transaction in which more than two identities can transact with each other over more than one networks.

Transactions between digital identities over a network can be made secure by network agents that have a trusted relationship and/or a secure and trusted channel between them. These network agents authenticate and authorize the transaction between the involved identities. As the transactions and related technology are progressing day by day, the number of transaction channels for transaction has also considerably increased. This has accelerated the race for owning these transaction channels in order to be connected and have an efficient and successful transaction all the time. The transaction is said to be successful and efficient if it is carried over the most preferred channel for that transaction. The preferred channel is selected on the basis of the asserted attributes, parameters and the preferences of the identities as given to the transaction enabling and control mechanism.

Most of the transaction enabling and control mechanisms in practice only support assertions at a single end-point or identity for any transaction. This results in lack of control on the transaction at the other end point or identity. The control mechanisms lack the ability to dynamically route the transaction based on assertions made by both the identities involved in the transaction and capability to dynamically direct the transaction to a channel that is preferred or neutrally associated by identities at both end points.

In light of the foregoing, there exists a need for providing a method and system for enabling the multi-party transaction by dynamically routing the transaction through a preferred channel, selected based on the ranking and matching of channels on the basis of asserted attributes and preferences by the different identities and the constraints posed by the compatibility of the channel and the underlying networks and platforms involved in the transaction.

### SUMMARY

An object of the invention is to provide a method and system for ranking transaction channels for enabling transactions between real world identities over networks.

Another object of the invention is to provide a method and system to enable multi-party or multi-identity transaction via ranked channels over one or more networks.

Yet another object of the invention is to provide a method and system for enabling the transaction based on the ranking of channels, depending on the inferred and asserted attributes and preferences by the different identities involved in the transaction.

Yet another object of the invention is to provide a method and system for dynamically routing a transaction through a most appropriate channel, selected based on the ranking and matching of channels asserted by identities involved in the transaction.

Yet another object of the invention is to enable transaction between multiple identities, based on a channel ranked on the basis of behavior and preferences of the identities, the constraints posed by the compatibility of the channel, and the underlying network(s) and platforms involved in the transaction.

Still another object of the invention is to provide a method and system to enable transaction between real world identities via the preferred channel based on the preference of the real world identity.

Various embodiments of the invention provide a method and system to facilitate transactions between real world identities. The system is configured with an inference mechanism which associates relationships between real world identities involved in the transaction. The relationships between the real world identities include bi-directional contracts between the identities. Further, system infers the contexts of the real world identities based on the assertions made by the real world identities and the spatial and temporal data inferred by the system. In order to enable transaction via the most appropriate channel, the system calculates channel ranking score for each channel, on the basis of availability of the channel, the asserted and inferred contexts and relationships between the real world identities. The matching of the channel between real world identities—which takes into consideration the preferences of the real world identities, the interoperability of the channels and the constraints posed by the underlying networks and platforms—is performed dynamically.

Various embodiments of the invention provide a method for ranking transaction channels for enabling transactions between two or more real world identities within one or more networks. Various transaction channels are associated with the real world identities. Relationships between the real world identities are associated, and contexts are asserted by the real world identities. The system also infers the relationships and contexts based on an identity's behavior and data mined from various networks. Thereafter, a channel ranking score for each transaction channel is computed, based on the availability of the channel; and contexts and the relationships for the real world identities. The channels are matched dynamically, and the most appropriate channel for transaction is selected based on the preferences of the real world identities, the interoperability of the channels and the constraints posed by the underlying networks and platforms.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a block diagram illustrating a real world identity, and its digital representation, in accordance with various embodiments of the invention;

FIG. 2 is a block diagram illustrating a transaction between two real world identities, in accordance with various embodiments of the invention;

FIG. 3 is a block diagram illustrating various components of a network builder and its interaction with the other elements in the system, in accordance with various embodiments of the invention;

FIG. 4 is a block diagram illustrating various components of the Social-Semantic Web builder (SSWB), and its interaction with the other elements in the system, in accordance with various embodiments of the invention;

FIG. 5 is a block diagram illustrating various components of the Social Semantic Web Consumer (SSWC), and its interaction with the SSWB, in accordance with various embodiments of the invention;

FIG. 6 is a flowchart illustrating an overall process for ranking transaction channels dynamically, in accordance with various embodiments of the invention;

FIG. 7 is a flowchart illustrating the process for enabling transactions, in accordance with an embodiment of the invention;

FIG. 8 is a flowchart, illustrating a process for channel ranking in accordance with another embodiment of the invention;

FIG. 9 is a flowchart, illustrating the process for enabling communication between the source and the destination identities, in accordance with an embodiment of the invention;

FIG. 10 is a flowchart, illustrating a process for updating the Social Semantic Graph (SSG), in accordance with an embodiment of the invention; and

FIG. 11 is a flowchart illustrating a process for updating the Equals Semantic Graph (ESG), in accordance with an embodiment of the invention.

### DETAILED DESCRIPTION OF EMBODIMENTS

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

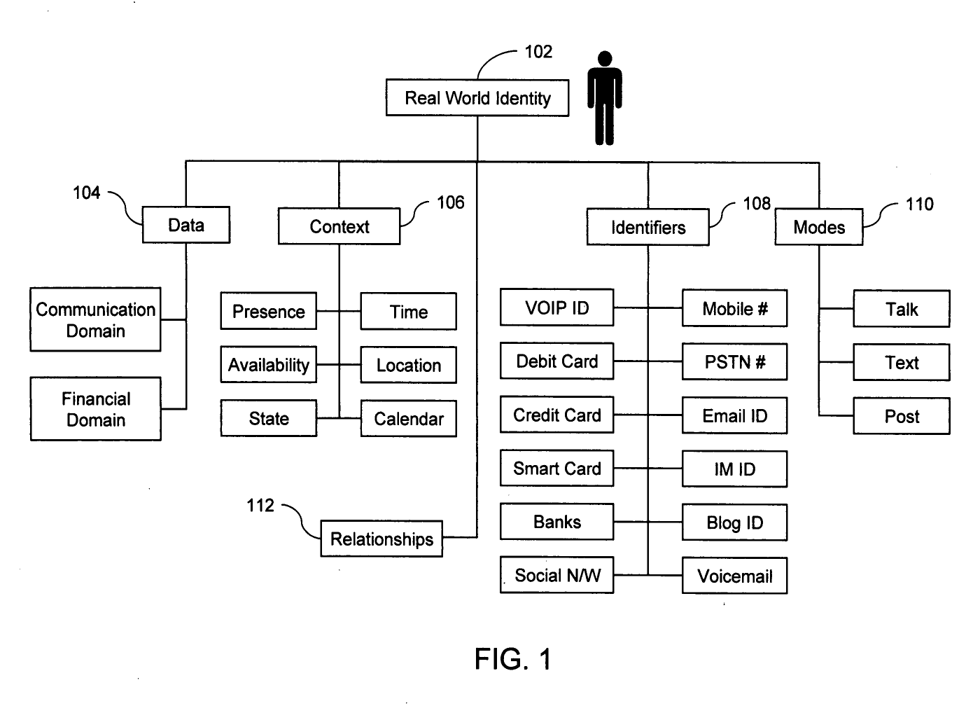

FIG. 1 is a block diagram illustrating a real world identity 102, and its digital representation, in accordance with various embodiments of the invention. The real world identity 102 can be associated with a set of attributes based on which channel ranking can be performed. This is done in order to enable a transaction over the most appropriate channel for transaction. The real world identity 102 can be abstracted from or resolved to the associated attributes. Each real world identity in a network is identified with a unique absolute address or identifier employed for addressing it using a channel within the given domain through the resolution process. The resolution can be static or dynamic. The abstraction process includes encompassing one or more such identifiers into a single, unique identifier that is capable of being resolved into different identifier(s), representing different channels of transaction, within the respective domain(s) and network(s). The different attributes that are associated with the real world identity 102, and to which the real world identity 102 can be resolved include, but are not limited to, data attributes 104, context attributes 106, identifiers 108 and modes 110.

The data attributes 104 related to the real world identity 102 for the transaction include, but are not limited to, data attributes in the communication domain, and data attributes in the financial domain. The data attributes 104 in communication domain vary with the application being used by the identity 102. The examples of application in communication domain include but are not limited to, a social networking website like Friendster®, Linked In®, Bebo®, Orkut®, Facebook®. etc, mobile phones, Internet, Voicemail, and VoIP services such as Skype®, gtalk® and so forth. The examples of applications in financial domain include, but are not limited to, transactions that are carried out by using a debit card, a credit card, a smart card, an authorized processing bank, an authorized processing gateway, an acquiring bank, and a card issuing bank.

The real world identity 102 asserts temporal context attributes 106 as a step of computing the channel ranking score, in accordance with various embodiments of the invention. The context attributes 106 of the real world identity 102 include, but are not limited to the presence of real world identity 102, the time for the real world identity 102, the availability of the real world identity 102 on various channels, the location of the real world identity 102, the state of the real world identity 102, and the calendar of the real world identity 102. The attributes for the real world identity 102 are inferred on the basis of its behavior and data mined from underlying networks. The context of a real world identity 102 is derived as a function of context asserted by it and spatial and temporal contexts inferred.

The real world identity 102 is identified over a network by its associated identifier(s). An identifier associated with the real world identity 102 varies depending on the type of the network. These identifiers can be communication identifiers, or financial identifiers. The communication identifiers associated with the real world identity 102 include, but is not limited to, a mobile number, a PSTN number, an e-mail ID, a social networking service ID, an Instant Messenger ID, a Twitter ID, a blog ID, Voicemail, VoIP ID. Likewise, financial identifiers associated with the real world identity 102 include, but are not limited to, a debit card ID, a credit card ID, a smart card ID, an authorized processing bank ID, an authorized processing gateway, an acquiring bank, and a card issuing bank.

The real world identity 102 asserts modes in which a transaction can take place. The modes between two or more real world identity include but are not limited to Talk mode, Text mode, and Post mode. Each mode has its own associated channel of communication, channel of transaction, and gateways for enabling transactions. The state of each channel with their respective mode is further given in terms as ‘Available’, ‘Preferred’ and ‘Blocked’. The states of channels can be set as a preference by the real world identity 102 or as by the system on behalf of the real world identity.

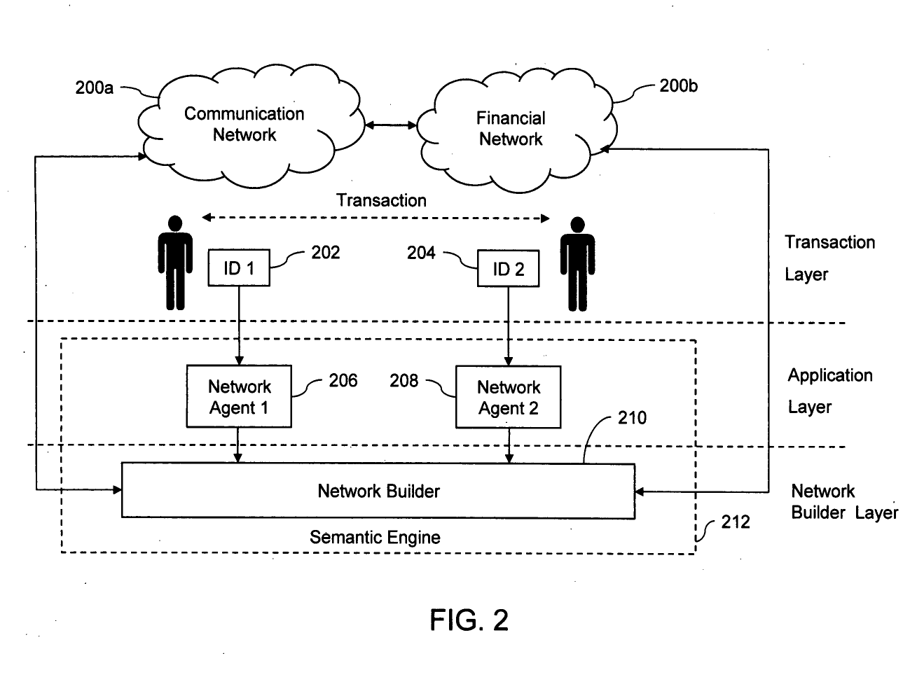

The real world identity 102 is involved in various transactions over one or more networks. This is further explained in conjunction with FIG. 2.

FIG. 2 is a block diagram illustrating a transaction between two real world identities ID1 202 and ID2 204, in accordance with various embodiments of the invention. The transaction between two or more real world identities involves basic steps of abstraction and resolution. The real world identities are represented using single, abstract, persistent identifiers ID1 202 and ID 204 using the abstraction procedure. The resolution procedure converts the single, abstract, persistent (channel/transaction independent) identifiers into various formats of the underlying identifiers 202 and 204.

Any transaction between the two identities has an associated control mechanism, that controls the choice of channel to be used for transacting and a transaction mechanism, which carries out the transaction in real-time. On receiving a request from an identity, the resolutions service first identifies the identity involved in the transaction request, based on the identity's associated absolute identifier and resolves the identity and its contexts, which is then made available to various applications for further processing.

In accordance with an embodiment of the invention, the several layers involved in a process of transaction are a Transaction layer, an Application layer, a Network Builder layer. The transaction between two or more real world identities may also involve various networks, over which the transaction is carried out. These networks include communication network 200a, and financial network 200b. The communication network 200a, financial network 200b and various other similar networks involved in the transaction are compatible with each other, in order to make the transaction complete and successful.

In accordance with an embodiment of the invention, the transaction layer is on the top of other two layers. The Transaction layer includes the networks, domains and platforms used by the two or more real world identities for transacting with each other. The real world identities assert contexts to the underlying layers through the transaction layer. The real world identity ID1 202 and ID2 204 can be part of different networks. In accordance with an embodiment of the invention, the Application layer interfaces with the networks, platforms and domains present in the transaction layer and the Network Builder layer. The main functions carried out by the Application layer include event handling and relaying of assertions, requests and data pertaining to the real world identities 202 and 204. The Application layer includes the network agent(s) 206 and 208 of the two respective real world identities 202 and 204, that intercept and interface the requests and responses between the transaction layer and the network builder layer.

A network agent agrees on how a real world identity 202 belonging to a network can make assertion (authentication, authorizations and associated attributes and parameters) to another real world identity 204 which belongs to another network.

1. Authentication of a real world identity 202 that network agent1 206 presents to network agent2 208.

2. Authorizations that a network agent1 206 would like network agent2 208 to accord to the identity being presented.

3. Associated parameters that network agent2 208 will need to complete the transaction with the real world identity being presented by network agent1 206.

The associated parameters include, but are not limited to, Data 104, Context 106, Identifiers 108 and Modes 110, which are required for providing desired quality of service, as specified by real world identities at either end of the transaction.

The Network Builder layer includes a Network Builder 210. The Network Builder 210 performs operations such as building a social semantic graph that represents the real world identities 202 and 204, and the data associated with them, logging transactions between the two real world identities 202 and 204, caching the data related to the real world identities 202 and 204, drawing inferences based on an identities behavior, mining data related to an identity from underlying networks, platforms and domains, computing the channel ranking score, updating the context, relationship etc, building the relationships, represented through contracts between the real world identities 202 and 204 involved in the transaction.

A contract exists between the two or more real world identities. That is, an identity (or a group of individuals), with itself as a constituent, establishes a contract with other real world identities.

A contract between the two real world identities can be of two types—(1) contract between identities representing agents, capable of acting or communicating in the physical world (such as people, organizations, companies etc), and (2) a contract between agents having certain attributes in space and time.

Contexts of the real world identities 202 and 204 may change from time to time. Therefore, a process of updating the attributes is required to be present.

In case of a transaction request between two or more real world identities, the identities involved in the transaction communicate over network by resolving the identifiers and the respective end points. The network agents conduct the initial negotiations at the application layer level and then enable the transaction on the relevant network by using the system present in the Network Builder layer.

The communication networks 200a involved may be a social networking websites like Friendster®, Linked In®, Bebo®, Orkut®, Facebook®. etc, mobile phone network, Internet, VoIP networks etc. The financial networks 200b involved may be a payment network, such as VisaNet, proprietary Master card network etc.

The network elements at the application layer and the Network Builder layer are a part of Semantic Engine module 212.

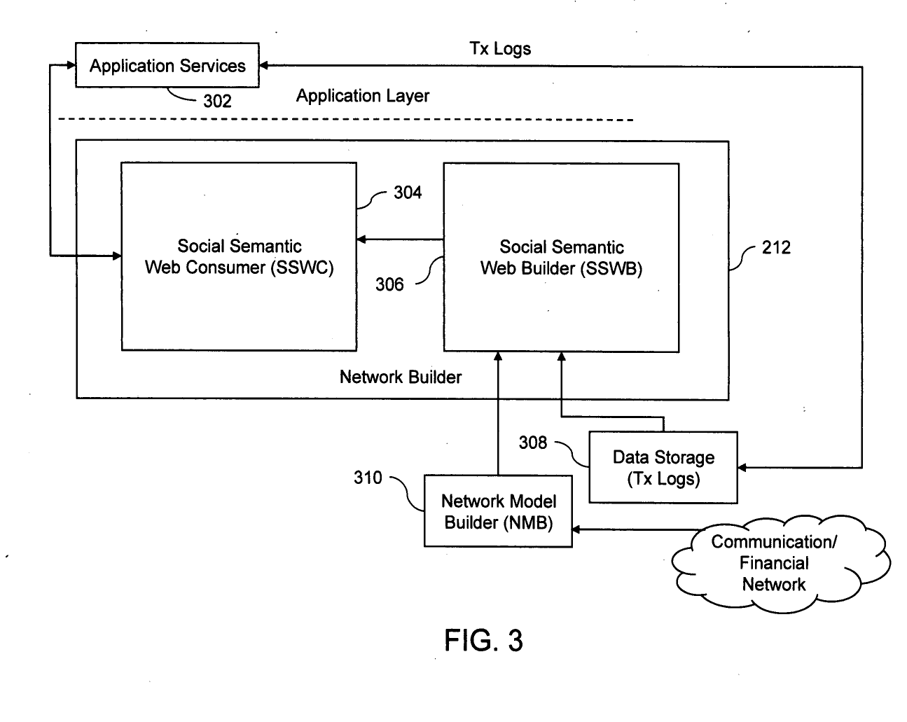

FIG. 3 illustrates various components of the network builder 210 and its interaction with the other elements in the system used to enable the transaction between identities 202 and 204, in accordance with various embodiments of the invention. The network builder 210 is a part of Network Builder layer as described in conjunction with FIG. 2. In accordance with various embodiments of the invention, the network builder 210 includes two main components—a Social Semantic Web Builder (SSWB) and a Social Semantic Web Consumer (SSWC). There may be various application services 302 through which the identity 202 and 204 can trigger the transaction. These application services 302 can provide services in various domains such as communications domain, financial domain etc.

The application services in communication domain include, but are not limited to, contacting a friend on a social networking website, such as Friendster®, Linked In®, Bebo®, Orkut®, Facebook®. etc, connecting a call using a mobile phone/fixed line phone, sending E-mails via Internet, and voicemails. The application services in financial domain include, but are not limited to, transaction using a debit card, a credit card, a smart card, an authorized processing bank, an authorized processing gateway, an acquiring bank, and a card issuing bank, and online money transfer.

The Application Services 302 transfers the transaction logs pertaining to all identities to a Data Storage unit 308. The data storage unit 308 is the storage for transaction data and logs. The data storage unit 308 includes a database containing transaction related histories of the identities involved in the transaction. The data from the data storage unit is transferred to the Social Semantic Web Builder (SSWB). Further, the Network Model Builder 310 converts the data mined from the various networks, platforms and domains into a model that can be consumed by the Social Semantic Web Builder (SSWB). Based on the transaction log data and the data mined from various sources, the Social-Semantic Web builder (SSWB) 306 builds and updates a Social Semantic Graph.

Social-Semantic Web builder (SSWB) 306 builds a Social Semantic Graph (SSG) based on all that is happening between the two real world Identities on the underlying networks, platforms and domains. The latest and past happenings between the real world identities in terms of transactions and the context of the transaction, the changes identities make in their personal profile documents online, change in preferences etc is reflected in a form of update in Social Semantic Graph (SSG). The SSG represents a system that is structurally/logically coupled with the physical world. For example, a social network, which is a social structure made of real world identities (which are generally individuals or organizations) that are tied by one or more specific types of interdependency, such as values, visions, ideas, financial exchange, friendship, kinship, dislike, conflict or trade. The Social Semantic Graph (SSG) is a connected world representation that extracts and receives data about the identity, its presence, and changes in state through a series of inference, induction and reasoning procedures.

The data from the Social-Semantic Web builder (SSWB) is pushed to the Social-Semantic Consumer (SSWC) 304. The Social-Semantic Web Consumer,(SSWC) 304 interprets the Social-Semantic web stored in the Social Semantic Graph (SSG) as a set of communications networks, social-semantic networks, micro-social networks, networks of locality and subtypes of networks thereof. This interpretation leads to the formation of a graph referred to as ‘Equals Social Graph’, which has unified user identities as the nodes, and contracts between these identities as the edges. The SSWC draws 2 types of inferences—(a) inferences about individual contracts and people (b) inferences about the world represented in the SSG.

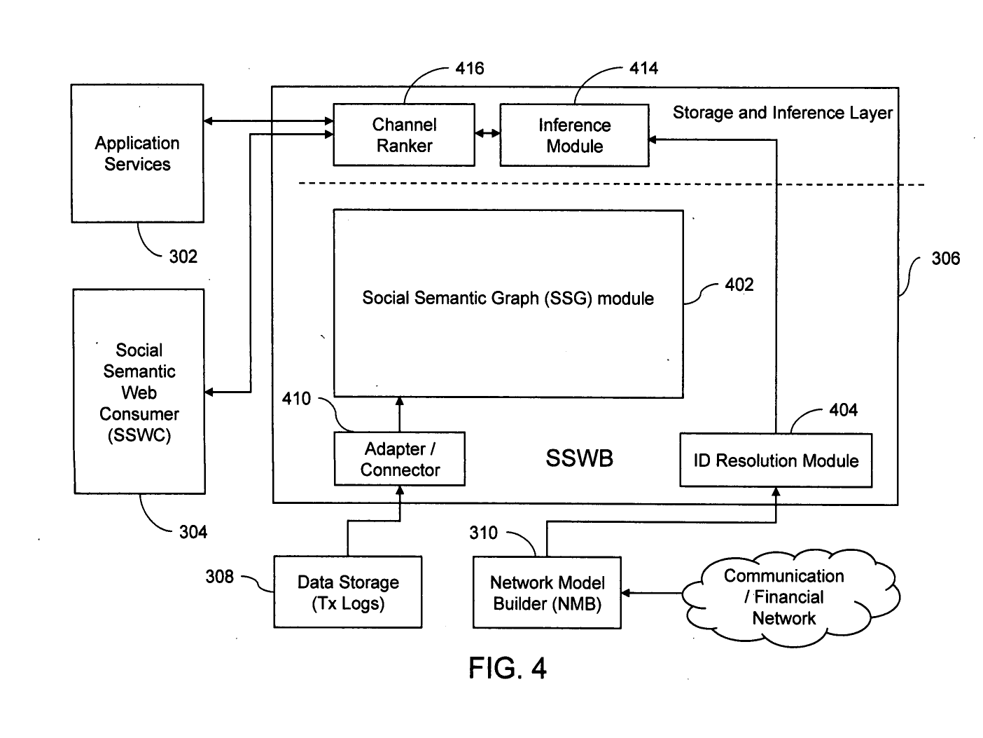

FIG. 4 is a block diagram illustrating various components of the Social-Semantic Web builder (SSWB) 306, and its interaction with the other elements of the system, in accordance with various embodiments of the invention. The application services 302 as illustrated in FIG. 3 uses the components of SSWB 306 to enable the transaction. In accordance with various embodiments of the invention, the SSWB 306 comprises of a Channel Ranker 416, an inference module 414, a Social semantic Graph Module (SSG) 402, an Adapter 410 and an Identity resolution module 404.

The SSWB 306 is related to the concept of Social Semantic Web. The Social Semantic Web subsumes developments in which social interactions on the Web lead to the creation of explicit and semantically rich knowledge representations. The Social Semantic Web can be seen as a Web of collective knowledge systems, which are able to provide useful information based on human contributions and which gets better as more and more people participate. The Social Semantic Web combines technologies, strategies and methodologies from the Semantic Web, Social Software and the Web 2.0.

The Social-Semantic Web builder (SSWB) 306 builds a Social Semantic Graph (SSG) based on the inputs received as transaction logs and model from Data Storage 308 and Network Model Builder 310 respectively. The SSG is based on all that is happening between the two real world Identities. The data storage module 308 stores the logs for every transaction and any change in the context or relationship between the identities in the network. The data storage module 308 transfers the information stored in it to the SSG 402. Adapter 410 acts as a coupler between the SSG module 402 and the data storage module 308. The adapter 410 is a device used to match the characteristics of the SSG module 402 and the data storage module 308 in order to enable data transfer between them. The adapter 410 can be any type of coupling module, known in the art, which makes the SSG module 402 and the data storage module 308 compatible with each other.

The Social Semantic Graph Module 402 retrieves the transaction logs through the Adapter 410. The nodes of Social Semantic Graph (SSG) 402 are arbitrary Resource Description Framework (RDF) subjects/objects identified by Uniform Resource Identifier (URIs). The edges of this graph are RDF predicates for relationships defined by some Web Ontology Language (OWL). The SSG 402 supports sophisticated semantic reasoning and learning. It supports people search based on the meaning of search keywords, probabilistic inferences about people and their relationships, and other operations. The Equals Social Graph 502 is overlaid on top of the SSG 402, and the two are semantically linked by using URI's, based on I-names (text) or I-numbers (numbers). I-names or I-numbers are a type of Internet identifiers which are designed to solve the problem of how any resource can have a persistent identity that never changes, even when the resource moves or changes its human-friendly name. For example, if a Web page has an I-number, and links to that page use the I-number, then those links will not break even if the page is renamed, the website containing the page is complete reorganized, or the page is moved to another website. The communication network can be a combination of networks such as the WWW, mobile networks, PSTN networks etc. The WWW depicts the vast network connecting large number of identities across the world, it is better known as the Internet.

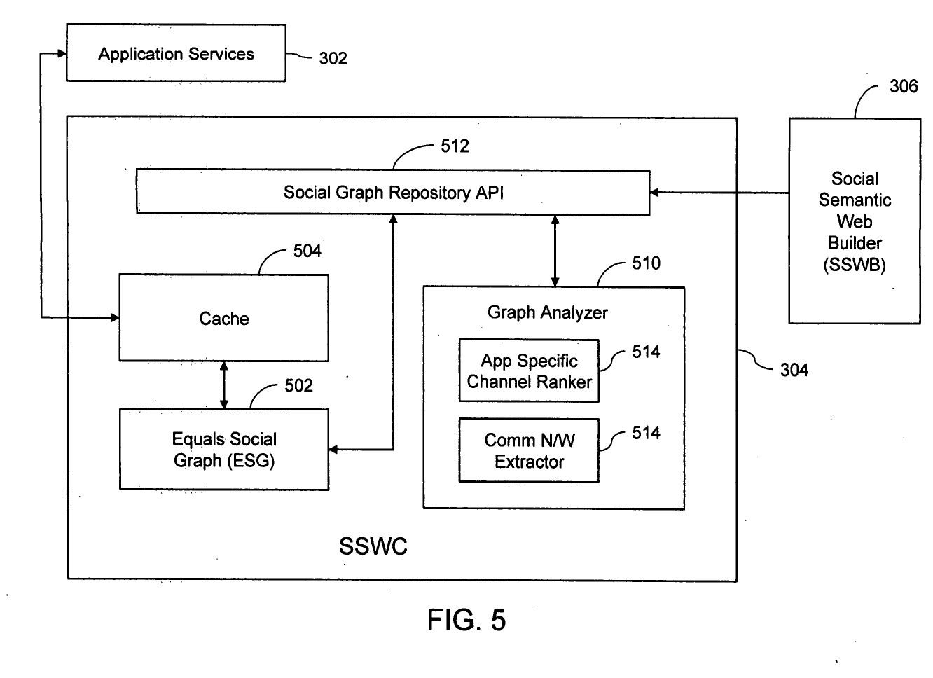

In accordance with an embodiment of the invention, the communication network, a financial network, or particularly, a third Party Social Network, like Friendster®, Linked In®, Bebo®, Orkut®, Facebook® is connected to applications services 302. These networks are present in the transaction layer, where all the real world transactions between identities take place. Application Services 302 provide services to facilitate the operation. The World Wide Web (WWW) or a financial network feeds the information to Network Model Builder (NMB) 310. As identities interact with each other according to the invention, the NMB processes the profile feeds of the identities and enriches an Equals Social Graph (ESG) 502. The description of ESG 502 is provided later in the description of this FIG. 5.

The Network Model Builder (NMB) 310 is connected to an Identity resolution module 404. The Identity resolution module 404 carries out an operational intelligence process. The Identity Resolution Module 404 can be powered by an identity resolution engine, where the networks can connect the identity in order to view the matches and relationships across multiple identities. It analyzes all of the information relating to individuals identity, and then applies the probability scoring to determine which identities are a match and what relationships exist between those identities.

The feeds from communication networks, financial networks or social networks have different representations. The NMB 310 harmonizes them before processing.

In accordance with an embodiment of the invention, a channel ranker 416 which is a part of storage and inference layer is used for ranking the channels. The channel ranker gets inferences from SSG 402 and stores a resolved ID from Identity resolution module 404. The channel ranking is done using a special inference engine called a probabilistic reasoner, which returns channels in order of probability 0 to 1. The inferences drawn by the inference engine are used to further update the SSG 402 and this process is carried out iteratively, In the event of the inferences crossing a certain threshold, the inferences are pushed to the Social Semantic Web Consumer (SSWC) 304. The inferences drawn by the inference engine help in automatic update to the context and relationships with the Micro-Social network of identities related to the identity. Further the Social Semantic Web Consumer (SSWC) 304 also periodically retrieves the ranked channels and inferences.

FIG. 5 is a block diagram illustrating various components of the Social Semantic Web Consumer (SSWC) 304, and its interaction with the SSWB 306, in accordance with various embodiments of the invention.

In accordance with an embodiment of the invention, the Social Semantic Web Consumer (SSWC) 304 retrieves inferences, data and channels that are ranked on a probability basis, from the storage and inference layer of the SSWB 306. The Social Semantic Web Consumer (SSWC) 304 comprises of an Equals Social Graph module 502, a Cache 504, a Graph Analyzer 510, and a Social Graph Repository API 512.

In accordance with an embodiment of the invention, the retrieved inferences, data and ranked channels first interface with the Social Graph Repository API 512. The Social Graph Repository API 512 is an Application Programming Interface to access the Social Semantic Graph from various components of SSWC 304. The Social Graph Repository API 512 facilitates the discovery of publicly declared relationships between people. The Social Graph Repository API 512 enables an identity to search for web-links, pages etc that are associated with an individual's profile in many other social networks, or blogs and websites associated with an identity. In addition to this, the Social Graph Repository API 512 also facilitates searches for implicit (like a friend of a friend) or suggested (more than ‘n’ number of common known identities) relationships between identities. This can come from standard links between blogs that imply relationships, or explicitly stated relationships of the formats that are used in social networks XHTML Friends Network (XFN) which is a way to add metadata to links suggesting the relationship with that link (friend, co-worker, relative, and so on) or the Friend of a Friend format (FOAF), an RDF structure and so on.

The Social Graph Repository API 512 further extracts models for each identity and contracts from the Graph Analyzer 510. The Graph Analyzer 510 uses statistical social network analysis methods to analyze the Social Semantic Graph. The Graph Analyzer 510 ranks channels from an application specific requirement/query. The Graph Analyzer 510 returns ranked channel metrics, which are stored in the Equals Social Graph (ESG) 502.

The Graph Analyzer 510 further comprises two other elements —an Application specific Channel Ranker module 514 and a Communication Network extractor 516. The Graph Analyzer 510 returns ranked channel metrics to the Equal Social Graph (ESG), on the other hand, the Communication Network extractor 516 gets inputs from Social Semantic Graph SSG from the SSWB 306; and based on the inputs such as data and inferences from the Social Semantic Graph SSG, it draws further inferences about identities and relationships. These inferences from the Communication Network extractor 516 are pushed to the Equals Social Graph module 502 through the Social Graph Repository API 512 which builds the Equals Social Graph (ESG).

The Equals Social Graph (ESG) is a global unified social graph of people (identities) and their relationships. This graph represents unified user identities as nodes, and relationships as links (edges). Each unified identity represents all the social network accounts, email accounts, phone accounts etc of a real world identity. The ESG is created as identities that use various applications. The ESG exposes Social Graph Repository API's for applications that allow them to retrieve and store data associated with the unified identities and efficiently perform graph operations such as determining social distance, finding common friends, and navigating through individual sub-graphs and cliques. ESG also contains information about an identity's Micro-Social Network, which comprises of the set of contracts and contexts pertaining to the currently relevant identities.

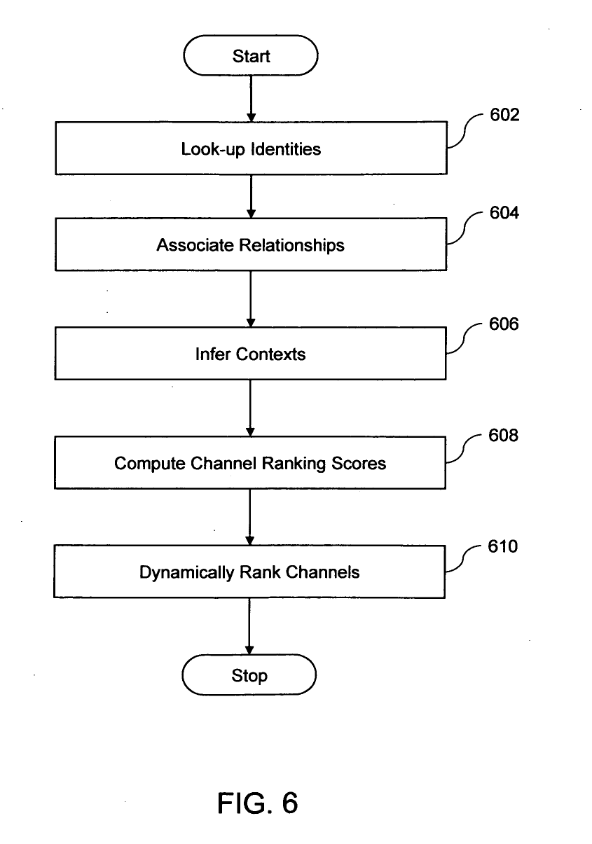

In accordance with an embodiment of the invention, Cache 504 stores updated information of any changes made to the various attributes and parameters associated with the underlying identities. The Cache 504 is a pre-serialized memory, which contains information such as context of the identities, contracts between identities, profiles of the identities and various other data pertaining to identities. The cache 504 also interfaces with the ESG Module 502, and stores the Equals Semantic Graph, which is updated from time to time. The procedure for this is further explained in conjunction with FIG. 6. The Cache 504 updates the information contained in it based on the requests posted at the application services 502 by the identities, and changes that are reflected in the Equals Semantic Graph.

FIG. 6 is a flowchart illustrating an overall process for ranking transaction channels dynamically for the initial condition of an identity, in accordance with various embodiments of the invention. At step 602, a look-up for establishing the identities involved in the transaction is performed by the system of the invention. After getting the source(s) and destination(s) identities, relationships are associated among them, at step 604. The associations are drawn by inter-personal ties that are publicly accepted and formalized by the identities and by inferences drawn by the system. In an embodiment of the invention, the relationships include the relationships as defined by the real world identities on various social networking sites, mobile address books, VoIP clients etc. For example, an Inner Circle of Friends, a colleague, a Trusted Friend, an acquaintance and so forth. The relationships may also be inferred by the system, depending on the status of various transactions stored in the cache 504. These relationships may have a strength quotient associated that indicates the level of closeness and connectivity between the identities. Based on the relationships asserted by the identities and the relationships inferred by the system, the relationships for between identities are established.

Similarly, identities have context asserted by them. The context of an identity includes one or more of a presence, time, a location, a state, and a calendar of the identity. Typically, and identity may specify the location information. Based on which, other context parameters can be inferred. At step 606, the system infers the spatial and temporal contexts for the identities involved in the transaction. For example, if an identity has moved from one location to the other location, its time zone, state etc. is inferred. Likewise, the contexts can also be inferred based on an identity's response to earlier transaction or communication request. For a given Relationship, based on the identity's response to a particular identity and simultaneously to other identities having same/different relationship, the system may infer a change in the context and may automatically create a ‘Situational Contract’ for the identity's time space.

For example, in case of a phone call, if an identity denies calls from identities with whom it shares different relationships, for multiple times repeatedly for a specific time space, an inference can be made that the context of the identity has changed. So although the asserted state available for the system at the instance of the transaction is ‘available’, it can be inferred that the identity is ‘busy’ or ‘unavailable’ or a new ‘Situational Contract’ for a new Context can be inferred and auto-created. A similar approach is also used to infer the relationships. For a given Context, based on an identity's response to a particular identity and simultaneously to other identities having same/different relationship, the system may infer a change in the relationship and automatically create a ‘Situational Contract’ for the identity's time space. Interpersonal ties between the identities measure the ‘Social Distance’ between identities and are of two types—the ones specifically asserted by the identities, and the ones that are inferred by the system.

In other words, the system learns channels and modes, learnt by the system based on the data generated in the execution of previous contracts/transactions. This includes: (a) recency and frequency of invocation of the contract, (b) channels used for all transactions occurring for a given contract, (c) relationships allocated by each identity to the other—either explicitly mentioned by the identities or as the system has inferred them, (d) the context, comprising of the state, location, time, presence and calendar of all identities involved in the transaction.

At step 608, channel ranking scores are computed. Based on the contexts inferred by the system, the associated relationships, social distance between the identities and their interpersonal ties, preferred, available and blocked transaction channels, and modes; a channel ranking score for every channel that may potentially be involved in communication is computed.

Thereafter, at step 610, the systems dynamically ranks the transaction channels based on space time criteria to determine connectiveness for the identity, presenting only the micro-social network (on the suitable channels) that is relevant to the identity at any point in time. As this process happens again and again, the learning of the system grows over time and transactions. The system infers from the responses from the identity and underlying network to update (push) the inference to the ESG 502 and further to the cache 504, which is pre-serialized.

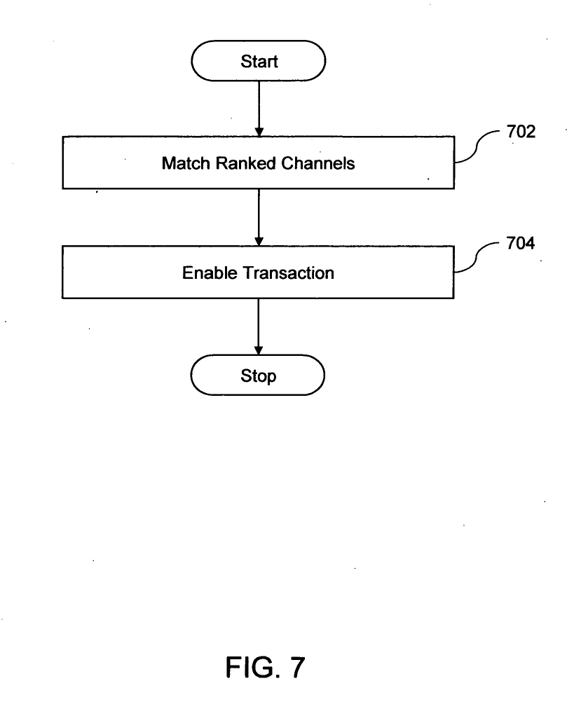

FIG. 7 is a flowchart illustrating the process for enabling transactions, in accordance with an embodiment of the invention. When the channel ranking scores are computed, and the channels are ranked as explained in conjunction with FIG. 6, the system matches the transaction channels at step 702. The most appropriate channel for transaction is selected on the basis of preferences by the identities involved and the constraints posed by the compatibility of the channels and the compliance with the underlying networks and platforms. For example, a preferred or an available channel is given higher preference over a blocked channel and so forth. Thereafter, the transaction between the source(s) and destination(s) identities is enabled at step 704. The transaction is carried out at the transaction level, through the underlying networks. The process explained through FIGS. 6 and 7 is repeated for every instance of transaction. As the system gets more and more inputs through the transaction logs, the process of inferring and selection of the most appropriate channel for transaction is enhanced and carried out efficiently.

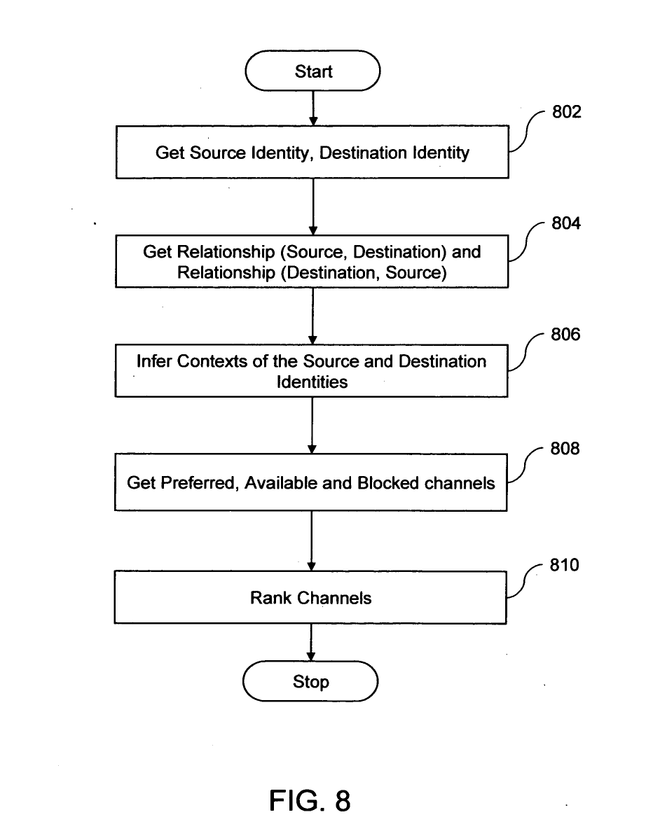

FIG. 8 is a flowchart, illustrating a process for channel ranking in accordance with another embodiment of the invention. At step 802, the source(s) and the destination(s) identities are identified. This is done by performing a look-up for the source(s) and the destination(s) identities by the system using their respective absolute identifiers. Further, at step 804, the relationships allocated by the source identity to the destination identity; and the relationship allocated by the destination identity to the source identity are obtained. Also, at step 806, the asserted, spatial and temporal contexts of the source and the destination identity are inferred by the system, as explained in conjunction with FIG. 6.

At step 808, the ‘preferred’, ‘available’ and ‘blocked’ channels of communication for the identities are obtained. These channels correspond to the three modes—‘talk’, ‘text’ and ‘post’. The channels are ranked as explained below.

In an embodiment of the invention, the system analyzes each identity's address book, and then builds a graph—the Social Semantic Graph, The data and inferences drawn from this graph acts as inputs to another abstracted graph—the Equals Semantic Graph (ESG)—as explained earlier. This graph has the unified identities at the nodes and the relationships or contracts as the links (or edges) between the nodes. Further, each edge has a score that indicates the level and intensity of connectivity with the adjacent node.

When an existing contact initiates a transaction, such as a VoIP call, with another identity, based on the ranking and matching of channels, the destination identity gets an intimation of the transaction request on the most appropriate transaction channel. In this case, the call from the source identity flashes on the destination identity's mobile phone or computer. The destination identity has an option to answer or reject this call. When the call is accepted by the destination identity, the source identity is moved closer to the destination identity in the Equals Social Graph. In other words, the ‘Social distance’ between the ‘Destination—>Source’ identities is reduced and the respective score that indicates the level and intensity of destination identity's connectivity with the source identity increases. Similarly, when the destination identity rejects the call, the ‘Social distance’ between the Destination—>Source' identities increases and the respective score that indicates the level and intensity of destination identity's connectivity with the source identity decreases.

At step 810, the systems ranks the transaction channels for the source and the destination identities based on space time criteria. Based on responses by both identities, the learning of the system grows over time and transactions. The system infers from the responses from the identities and underlying network to update (push) the inferences to the ESG module 502, which further updates the cache 504, which is pre-serialized. The process of ranking and matching the channels happens dynamically.

The logs of all such transaction are maintained in the Data Storage (Tx logs) 308. These transactions are further expanded based on the identity's asserted and inferred contexts, contact's personal profile documents and associated attributes and data.

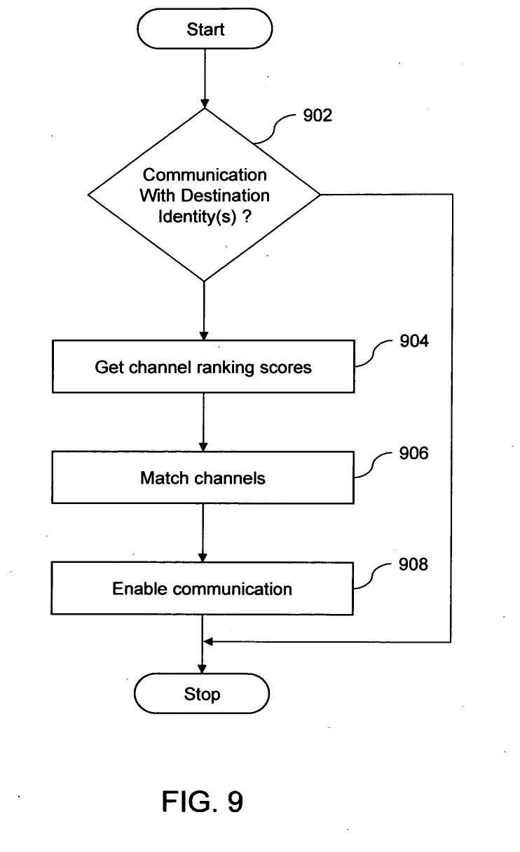

FIG. 9 is a flowchart, illustrating the process for enabling communication between the source and the destination identities, in accordance with an embodiment of the invention. At step 902, the network agent 206 checks if there is a request initiated by the source identity 202, for communicating with the destination identity 204. The channel ranking scores for individual identities, as computed by using the algorithm explained above, are obtained at step 904. The channels are matched at step 906, and communication is enabled by using the most appropriate channel for communication, at step 908. For every instance of transaction, communication, context change, data change, mode change, addition of an identity, addition of data, the Social Semantic Graph (SSG) and the Equals Social Graph (ESG) need to be updated. The cache 504 is pre-serialized and gets updated by the ESG Module 502.

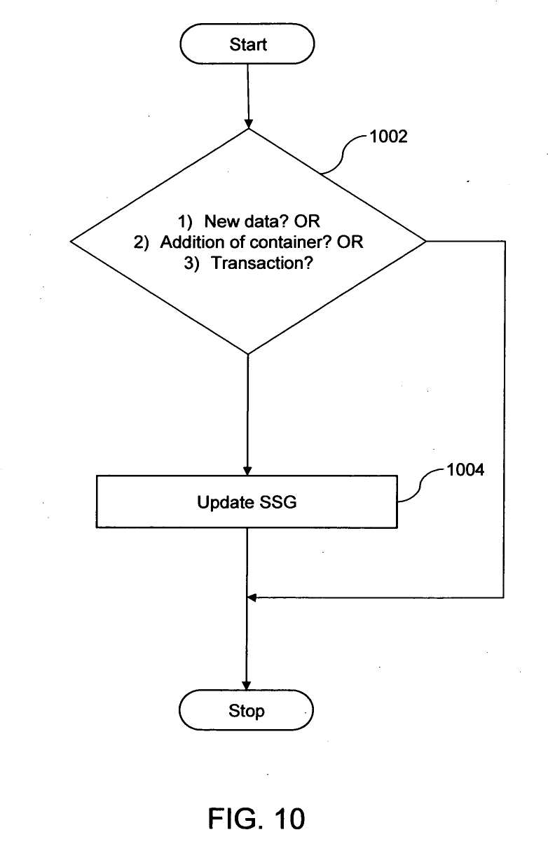

FIG. 10 is a flowchart, illustrating a process for updating the Social Semantic Graph (SSG), in accordance with an embodiment of the invention. At step 1002, it is checked if there is (a) new data being introduced; or (b) addition of a new container; or (c) a transaction that took place. In case new data is being added, the adapter 410 matches the characteristics of the data being added with those required by the SSG module 402, and converts the data to enable the data transfer between them. In case of addition of a new Container, such as mobile address book or a Facebook account, the Network Model Builder 310 converts the data mined from the various networks, platforms and domains into a model that can be consumed by the SSG module 402. In case of a new transaction, the inference module in SSWB 306, expands and infers from the transaction. At step 1004, the Social Semantic Graph is updated appropriately by all three sources mentioned above.

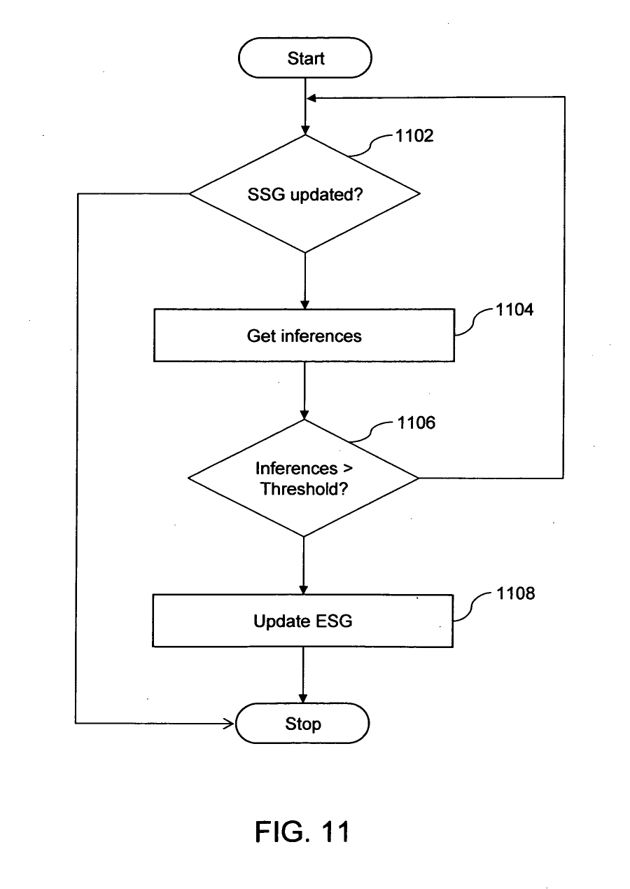

FIG. 11 is a flowchart illustrating a process for updating the Equals Semantic Graph (ESG), in accordance with an embodiment of the invention. At step 1102, it is checked if there is an update to the Social Semantic Graph (SSG). When there is an update to SSG (explained above), at step 1104, inferences are drawn about the contexts and relationships of the identities.

In the beginning, as the number of updates to the Social Semantic Graph is less, it may not be appropriate to establish context/relationships for the source and the destination identities, since the inferences may be based on temporary or exceptional assumptions. Therefore, a threshold value is decided, at which it is appropriate to draw conclusions by the system about the context and relationship changes. This is an optimized number, at which the system's confidence in drawing conclusions is high.

At step 1106, it is checked whether the number of inferences so far exceeds the threshold value. In case the number of inferences is less than the threshold, the system relies on the asserted contexts/relationships or the latest values of the contexts and relationships. In case the number of inferences is greater than the threshold value, at step 1108, the Equals Semantic Graph (ESG) is updated appropriately.

It will be appreciated by a person skilled in the art that the process here is explained for a source identity and a destination identity only. It does not restrict the scope of the invention in any way. The invention is equally applicable to multiple source and multiple identities. Similarly, multiple communication and financial networks are supported for transaction.

The system, as described in the invention, or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps constituting the method of the invention.

The computer system may comprise a computer, an input device, and a display unit. The computer comprises a microprocessor, which is connected to a communication bus. The computer also includes a memory, which may include Random Access Memory (RAM) and Read Only Memory (ROM). Further, the computer system comprises a storage device, which can be a hard disk drive or a removable storage drive such as a floppy disk drive, an optical disk drive, and the like. Furthermore, the storage device can be other similar means for loading computer programs or other instructions on the computer system.

To process input data, the computer system executes a set of instructions that are stored in one or more storage elements. The storage elements may also hold data or other information, as desired, and may be an information source or physical memory element present in the processing machine.

The set of instructions may include various commands that instruct the processing machine to perform specific tasks such as the steps constituting the method of the invention. The set of instructions may be in the form of a software program. The software may be in various forms such as system or application software. The software may also be in the form of a collection of separate programs, a program module with a larger program, or a portion of a program module. Moreover, the software may include modular programming in the form of object-oriented programming. Processing of input data by the processing machine may be in response to user commands, to the results of previous processing, or to a request made by another processing machine.

We claim:

1. A method for ranking transaction channels for enabling transactions between two or more real world identities within one or more networks, wherein one or more transaction channels are associated with each of the two or more real world identities, the method comprising:
a. associating relationships between each of the two or more real world identities;
b. asserting contexts by each of the two or more real world identities;
c. computing a channel ranking score for each transaction channel, based on the availability of the channel; and contexts and the relationships for each of the two or more real world identities; and
d. dynamically ranking the channels based on the channel ranking scores.

2. The method as recited in claim 1 further comprising matching the ranked channels between each of the two or more real world identities based on a compatibility between the channels and preferences of the each of the two or more real world identities.

3. The method as recited in claim 1 further comprising enabling the transaction between the two or more real world identities, based on the matched channels.

4. The method as recited in claim 3, wherein enabling the transaction between each of the two or more real world identities comprises enabling the transaction on a most appropriate channel of transaction, based on the ranking of the channels.

5. The method as recited in claim 1, wherein the relationships between the two or more real world identities comprise bi-directional contracts between the two or more real world identities.

6. The method as recited in claim 5, wherein the bi-directional contracts are inherited from interpersonal ties between the two or more real world identities.

7. The method as recited in claim 5, wherein the contracts are specifically asserted by the two or more real world identities.

8. The method as recited in claim 5, wherein the contracts are automatically inferred.

9. The method as recited in claim 1, wherein the contexts comprise one or more of: a presence, a state, a calendar, a location, availability, a time zone of the two or more real world identities.

10. The method as recited in claim 1, wherein the step of computing the channel ranking score comprises updating the channel ranking score when there is a change in one or more of: the contexts of one of the two or more real world identities and the relationship between the two or more real world identities.

11. The method as recited in claim 1, wherein ranking the channels comprises arranging one or more channels in a preferred order for the transaction, based on the channel ranking score.

12. The method as recited in claim 1 further comprising updating the contexts of each of the two or more real world identities, based on the transactions between the two or more real world identities.

13. The method as recited in claim 1 further comprising updating the relationships between the two or more real world identities, based on the transactions between the two or more real world identities.

14. The method as recited in claim 1, wherein the transaction channels are channels of a communication domain.

15. The method as recited in claim 1, wherein the transaction channels are channels of a financial domain.

16. The method as recited in claim 1, wherein the transactions comprise transactions carried out by using one or more of: a mobile number, a PSTN number, an e-mail ID, a social networking service ID, an Instant Messenger ID, a Twitter ID, a blog ID, Voicemail, VoIP ID, a debit card, a credit card, a smart card, an authorized processing bank, an authorized processing gateway, an acquiring bank, and a card issuing bank.

17. A method for enabling transactions between two or more real world identities within one or more networks, wherein one or more transaction channels are associated with each of the two or more real world identities, the method comprising:
a. associating relationships between each of the two or more real world identities;
b. asserting contexts by each of the two or more real world identities;
c. computing a channel ranking score for each transaction channel, based on the availability of the channel; and contexts and the relationships for each of the two or more real world identities;
d. dynamically ranking the channels based on the channel ranking scores;
c. matching the ranked channels between each of the two or more real world identities based on a compatibility between the channels and preferences of the each of the two or more real world identities; and
d. enabling the transaction between the two or more real world identities, based on the matched channels.

18. A system for enabling transactions between two or more real world identities within one or more networks, wherein each of the two or more identities assert contexts over the one or more networks, the system comprising:
a. means for associating relationships between each of the two or more real world identities;
b. a channel ranker configured for computing a channel rank score for transaction channels, based on the availability of the channels, contexts and the relationships between the two or more real world identities; and
c. means for enabling transactions based on the channel rank score.

19. The system as recited in claim 18, wherein the channel ranker comprises:
a. a score computing module configured for computing channel ranking scores;
b. a ranking module configured for dynamically ranking the channels based on the channel ranking scores; and
c. a channel matching module configured for matching the ranked channels.

20. The system as recited in claim 18 further comprising:
a. a storage module configured for storing the logs of the transactions;
b. a social semantic graph (SSG) module configured for generating and storing a social semantic graph; and
c. an adapter for enabling communication between the storage module and the social semantic graph module.

21. The system as recited in claim 18 further comprising:
a. a network model builder configured for extracting the relationships between the two or more real world identities; and
b. an identity resolution module configured for resolving the channels.

22. The system as recited in claim 18 further comprising:
a. an Equals social graph module configured for generating and storing an Equals social graph (ESG);
b. a graph analyzer configured for dynamically calculating application specific channel rank score data; and
b. a cache memory configured for storing the application specific channel rank score data.

23. The system as recited in claim 18, wherein the channel ranker comprises:
a. a score computation module configured for computing channel ranking scores for the transaction channels;
b. a channel ranking module configured for dynamically ranking the transaction channels based on the channel ranking scores; and
c. a channel matching module for matching the ranked transaction channels.
